(19) United States
(12) Patent Application Publication
(10) Pub. No.: US 2015/0066584 A1
(43) Pub. Date: Mar. 5, 2015

(54) SYSTEM AND METHOD FOR ACQUIRING AN UNDERSTANDING OF A BUSINESS SEGMENT

(71) Applicant: MASTERCARD INTERNATIONAL INCORPORATED, Purchase, NY (US)

(72) Inventors: Adam Michael Granoff, Greenwich, CT (US); Jean Pierre Gerard, Croton-on-Hudson, NY (US)

(73) Assignee: MASTERCARD INTERNATIONAL INCORPORATED, Purchase, NY (US)

(21) Appl. No.: 14/017,855

(22) Filed: Sep. 4, 2013

(51) Int. Cl. G06Q 30/02

(52) U.S. Cl. CPC G06Q 30/0201
USPC 705/7.29

(57) ABSTRACT

A method for acquiring an understanding a business segment is provided. The method comprises: storing in an electronic storage device a database of information in which the information is generated from at least four linked data sources including a firmographics data source, a risk data source, a transaction behavior data source, and an attitudinal data source; accessing information in the database concerning the business segment; and assembling the information concerning the business segment. The information from one or more of the linked data sources is summarized to a link, at least some of the information is integrated by data fusion, and at least some of the integrated information is imputed via the link to the business segment. The method also provides the assembled information to a user that has been granted access to the database. A system for acquiring an understanding of a business segment is also provided.

### BACKGROUND OF THE DISCLOSURE

1. Field of the Disclosure

The present disclosure relates to a method of and system for acquiring an understanding of a business segment. In particular, the present disclosure relates to using data fusion to summarize and impute information from one or more linked data sources to the business segment.

2. Description of the Related Art

The ability to act decisively in today's increasingly competitive marketplace is critical to the success of organizations. The volume of information that is available to corporations is rapidly increasing and frequently overwhelming. Those organizations that will effectively and efficiently use the information to make strategic business decisions, will realize a significant competitive advantage in the marketplace.

In addition to typical business information, such as credit reports and risk data, consumer activities and characteristics provide an effective form of information about a business that is useful for making strategic business decisions (e.g., product development, merger and acquisition activity, and the like). However, such consumer activities and characteristics information is often of limited access to third parties. For instance, a payment card company may have information regarding payment card billing, purchasing and payment transactions at various businesses, and optionally demographic and/or geographic information, that is not readily available to third parties, and so third parties are not able to use this information for strategic business decision making purposes.

Particularly, there are times that a specific company has access to information about a customer's activities and characteristics, based on the company's prior dealings with the customer, regarding a customer's personal circumstances that are not readily available to other companies. For instance, a payment card company will have access to certain customer data that indicates a purchasing and spending behavior at a retail company that is not apparent or known to third parties. Because the third party is not aware of the customer's personal circumstances, it cannot factor this information into strategic business decision making concerning the particular retail company.

Therefore, a need exists for a system that provides more effective and efficient use of information to make strategic business decisions. The system should include a more holistic database of information including a consumer's personal circumstances (e.g., spending habits and preferences). A system is needed that leverages consumer transaction data and small business attitudinal data in strategic decision making.

### SUMMARY OF THE DISCLOSURE

The present disclosure provides a method for acquiring an understanding a business segment. The method comprises: storing in an electronic storage device a database of information in which the information is generated from at least four linked data sources including a firmographics data source, a risk data source, a transaction behavior data source, and an attitudinal data source; accessing information in the database concerning the business segment; and assembling the information concerning the business segment. Information from one or more of the linked data sources is summarized to a link, at least some of the information is integrated by data fusion, and at least some of the integrated information is imputed via the link to the business segment. The method also includes providing the assembled information to a user that has been granted access to the database.

The present disclosure also provides a system for acquiring an understanding of a business segment. The system comprises: an electronic storage device having a database of information stored therein in which the information is generated from at least four linked data sources including a firmographics data source, a risk data source, a transaction behavior data source, and an attitudinal data source; an access path for allowing access to the information concerning the business segment; and a processor for assembling the information concerning the business segment. Information from one or more of the linked data sources is summarized to a link, at least some of the information is integrated by data fusion, and at least some of the integrated information is imputed via the link to the business segment. This system provides the assembled information to a user that has been granted access to the database.

The present disclosure still further provides a computer readable non-transitory storage medium storing instructions of a computer program which when executed by a computer system results in performance of steps of: storing in an electronic storage device a database of information; the information generated from at least four linked data sources including a firmographics data source, a risk data source, a transaction behavior data source, and an attitudinal data source; accessing the information in the database concerning a business segment; assembling the information concerning the business segment. Also, information from one or more linked data sources is summarized to a link, at least some of the information is integrated by data fusion, and at least some of the integrated information is imputed via the link to a business segment. The steps also include providing the assembled information to a user that has been granted access to the database.

### BRIEF DESCRIPTION OF THE DRAWINGS

FIG. 1 is a diagram of a four party payment card system.

FIG. 2 shows a data mart that houses and links information from four distinct sources that can be leveraged to develop insights to a business in accordance with the present disclosure.

FIG. 3 is a flow chart representing a method for generating one or more predictive behavioral models for the transaction behavior data source in an embodiment of this disclosure.

FIG. 4 illustrates an exemplary dataset for the storing, reviewing, and/or analyzing of information used in generating predictive behavioral models for the transaction behavior data source in accordance with the present disclosure.

FIG. 5 illustrates the summarization and imputation of data across the four existing sources via the SBIE link in accordance with the present disclosure. Data is summarized to the linkage level, and integrated summaries are imputed via the linkage.

FIG. 6 illustrates the summarization and imputation of data by which data is summarized to the linkage level, and integrated summaries are imputed via the linkage in accordance with the present disclosure. The summarization and imputation of data is illustrated by using two data sources and an illustrative SBIE link.

FIG. 7 shows illustrative information types included in each of the four linked data sources in accordance with the present disclosure.

FIG. 8 gives an illustration of a data fusion algorithm used with an attitudinal data source and a firmographic data source in accordance with the present disclosure.

FIG. 9 shows illustrative data fusion algorithm computation of aggregate measures of segments from survey data in accordance with the present disclosure.

A component or a feature that is common to more than one drawing is indicated with the same reference number in each of the drawings.

### DESCRIPTION OF THE EMBODIMENTS

Embodiments of the present disclosure now may be described more fully hereinafter with reference to the accompanying drawings, in which some, but not all, embodiments of the disclosure are shown. Indeed, the disclosure can be embodied in many different forms and should not be construed as limited to the embodiments set forth herein; rather, these embodiments are provided so that this disclosure may satisfy applicable legal requirements. Like numbers refer to like elements throughout.

As used herein, entities can include one or more persons, organizations, businesses, institutions and/or other entities, such as financial institutions, services providers, and the like that implement one or more portions of one or more of the embodiments described and/or contemplated herein. In particular, entities can include a person, business, school, club, fraternity or sorority, an organization having members in a particular trade or profession, sales representative for particular products, charity, not-for-profit organization, labor union, local government, government agency, or political party.

The steps and/or actions of a method described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to the processor, such that the processor can read information from, and write information to, the storage medium. In the alternative, the storage medium can be integral to the processor. Further, in some embodiments, the processor and the storage medium can reside in an Application Specific Integrated Circuit (ASIC). In the alternative, the processor and the storage medium can reside as discrete components in a computing device. Additionally, in some embodiments, the events and/or actions of a method can reside as one or any combination or set of codes and/or instructions on a machine-readable medium and/or computer-readable medium, which can be incorporated into a computer program product.

In one or more embodiments, the functions described can be implemented in hardware, software, firmware, or any combination thereof. If implemented in software, the functions can be stored or transmitted as one or more instructions or code on a computer-readable medium. Computer-readable media includes both computer storage media and communication media including any medium that facilitates transfer of a computer program from one place to another. A storage medium can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection can be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above are included within the scope of computer-readable media.

Computer program code for carrying out operations of embodiments of the present disclosure can be written in an object oriented, scripted or unscripted programming language such as Java, Perl, Smalltalk, C++, or the like. However, the computer program code for carrying out operations of embodiments of the present disclosure can also be written in conventional procedural programming languages, such as the “C” programming language or similar programming languages.

Embodiments of the present disclosure are described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions can also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions can also be loaded onto a computer or other programmable data processing apparatus to cause a series of operational steps to be performed on the computer or other programmable apparatus to produce a computer-implemented process so that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the present disclosure.

Thus, apparatus, systems, methods and computer program products are herein disclosed to generate business information concerning a business segment from at least four linked data sources including a firmographics data source, a risk data source, a transaction behavior data source, and an attitudinal data source. The business information concerning the business segment is assembled and data fusion is used to summarize and impute business information from one or more linked data sources to the business segment. The assembled information is provided to a user that has been granted access to the database.

Embodiments of the present disclosure will leverage the transaction behavior data source information available to identify data that is indicative of a customer's activities and characteristics and to predict consumer behavior and intent based on those activities and characteristics. Such activities and characteristics can include, but are not limited to, spending behavior, age, gender, residence, graduation from college, a new job, marriage, the birth of a child, the purchase of a house, the purchase of a car, and a member of the household starting college.

Embodiments of the present disclosure will also leverage attitudinal data source information to identify data that is indicative of attitudes of a small business. Such attitudes can include, but are not limited to, consumer spending behaviors, consumer purchasing behaviors, product trends, opportunities, and supply and demand.

In accordance with the present disclosure, an engine (i.e., a small business insights engine (SBIE) is provided that links and analyzes multiple sources of small business data to create a rich understanding of a small business segment. The SBIE also has other functions, for example, to provide information to a product development group of an entity. The SBIE utilizes and links at least four data sources to obtain a diverse and multifaceted understanding of the small business segment. The four data sources include firmographics, risk, transaction behavior and attitudes. The design of the SBIE can support additional data sources.

The linkage process uses a data fusion methodology to summarize and impute an entire data source to a common segment. For example, in accordance with this disclosure, the actual spend patterns of companies tagged as high risk sole proprietor in New York State can be tracked.

In accordance with the present disclosure, a system and a method are provided for acquiring an understanding of a business (e.g., a small business). The method generally includes storing in an electronic storage device a database of business information. The business information is generated from at least four linked data sources including a firmographics data source, a risk data source, a transaction behavior data source, and an attitudinal data source. The business information is accessed in the database concerning the business segment via an access path. The business information concerning the business segment is assembled, and data fusion is then used to summarize and impute business information from one or more linked data sources to the business segment. The assembled information is provided to a user that has been granted access to the database.

In some embodiments, the access path can include a web site for making the data in the database available to users of the web site. In particular, the access path includes an Internet connected device for connecting to the web site. The Internet connected device is a mobile telephone, a computer, a tablet, a personal digital assistant, or other suitable device.

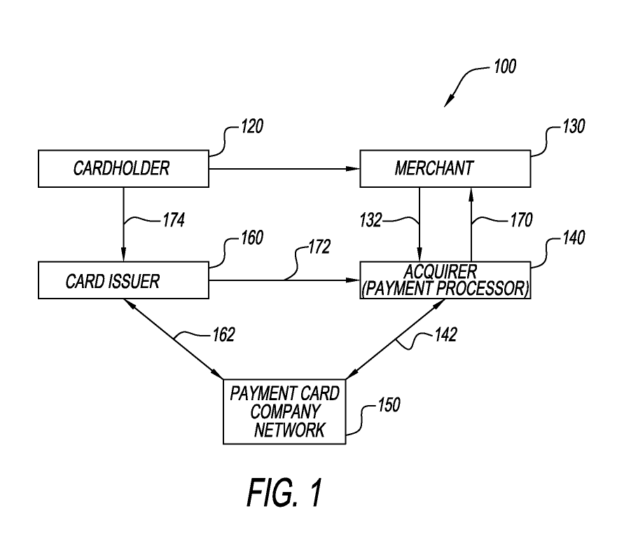

Referring to the drawings and, in particular, FIG. 1, there is shown a four party payment (credit, debit or other) card system generally represented by reference numeral 100. In card system 100, card holder 120 submits the payment card to the merchant 130. The merchant's point of sale (POS) device communicates 132 with his acquiring bank or acquirer 140, which acts as a payment processor. The acquirer 140 initiates, at 142, the transaction on the payment card company network 150. The payment card company network 150 (that includes the financial transaction processing company) routes, via 162, the transaction to the issuing bank or card issuer 160, which is identified using information in the transaction message. The card issuer 160 approves or denies an authorization request, and then routes, via the payment card company network 150, an authorization response back to the acquirer 140. The acquirer 140 sends approval to the POS device of the merchant 130. Thereafter, seconds later, the card holder completes the purchase and receives a receipt.

The account of the merchant 130 is credited, via 170, by the acquirer 140. The card issuer 160 pays, via 172, the acquirer 140. Eventually, the card holder 120 pays, via 174, the card issuer 160.

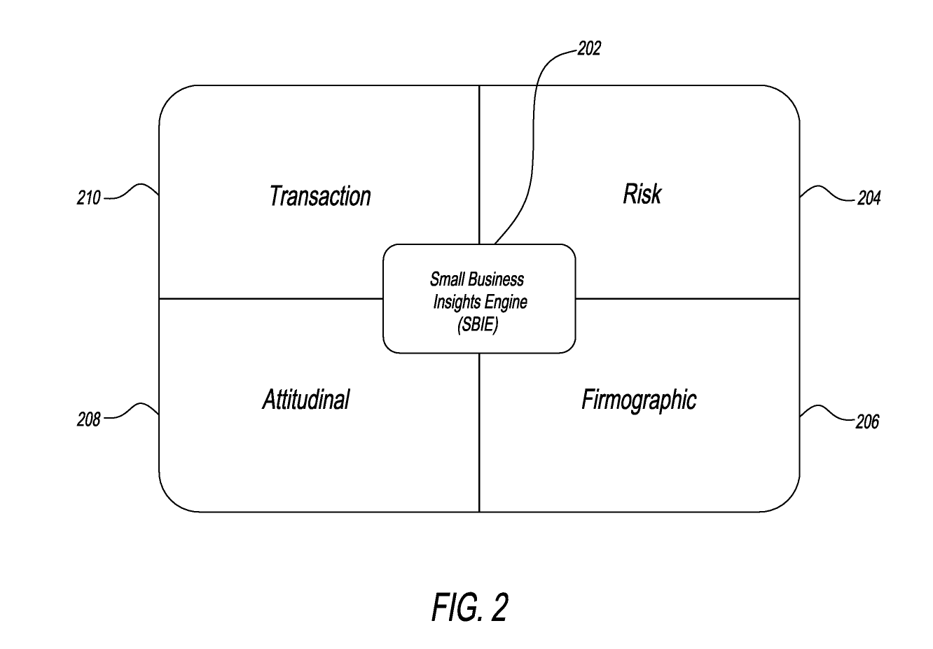

Referring to FIG. 2, a data mart is shown that houses and links information from four distinct sources that can be leveraged to develop insights to a business. The SBIE 202 utilizes and links four data sources to obtain a diverse and multifaceted understanding of the small business segment. The four data sources include firmographics 206 (e.g., information related to employees, revenues and industries), risk 204 (e.g., information related to open lines of credit, utilization and risk score), transaction behavior 210 (e.g., information related to payment card transactions, purchase clusters and actual spending) and attitudinal 208 (e.g., information related to payment card holder dynamics, satisfaction and concerns). The design of the SBIE 202 can support additional data sources.

The firmographics data source 206 includes information related to employees, revenues and industries. In particular, information for inclusion in the firmographics data source 206 relates to information on businesses and corporations for use in credit decisions, business-to-business marketing and supply chain management.

Illustrative information in the firmographics data source 206 includes, for example, information concerning business background, business history, business special events, business operation, business payments, business payment trends, business financial statement, business public filings, and the like.

Business background information can include, for example, ownership, history and principals of the business, and the operations and location of the business.

Business history information can include, for example, incorporation details, par value of shares and ownership information, background information on management, such as educational and career history and company principals, related companies including identification of parent, affiliates, subsidiaries and/or branches worldwide. The business history information can also include corporate registration details to verify the existence of a registered organization, confirm legal information such as a company's organizational structure, date and state of incorporation, and research possible fraud by reviewing names of principals and business standing within a state.

Business special event information can include, for example, any developments that may impact a potential relationship with a company, such as bankruptcy filings, changes in ownership, acquisitions and other events. Other special event information can include announcements on the release of earnings reports. Special events can help explain unusual company trends, for example, a change in ownership could have an impact on manner of payment, or decreased production may reflect an unexpected interruption in factory operations (i.e., labor strike or fire).

Business operational information can include, for example, the identity of the parent company, the number of accounts and geographic scope of the business, typical selling terms, and whether the company owns or leases its facilities. The names and locations of branch operations and subsidiaries can also be identified.

Business payment information can include, for example, a listing of recent payments made by a company. An unusually large number of transactions during a single month or time period can indicate a seasonal purchasing pattern. The information can show payments received prior to date of invoice, payments received within trade discount period, payments received within terms granted, and payments beyond vendor's terms.

Business payment trend information can include, for example, information that spots trends in a company's business by analyzing how it pays its bills.

Business financial statement information can include, for example, a formal record of the financial activities and a snapshot of a business's financial health. Financial statements typically include four basic financial statements, accompanied by a management discussion and analysis. The Balance Sheet reports on a company's assets, liabilities, and ownership equity at a given point in time. The Income Statement reports on a company's income, expenses, and profits over a period of time. Profit & Loss account provide information on the operation of the enterprise. These include sale and the various expenses incurred during the processing state. The Statement of Retained Earnings explains the changes in a company's retained earnings over the reporting period. The Statement of Cash Flows reports on a company's cash flow activities, particularly its operating, investing and financing activities.

Business public filing information can include, for example, bankruptcy filings, suits, liens, and judgment information obtained from Federal and State court houses for a company.

The risk data source 204 includes information related to open lines of credit, utilization and risk score. In particular, information for inclusion in the risk data source 204 relates to information concerning credit services, marketing services, decision analytics and consumer services. The risk data source 204 can also include information on people, businesses, motor vehicles and insurance. The risk data source 204 can also include ‘lifestyle’ data from on-line and off-line surveys.

The transaction behavior data source 210 includes information related to payment card transactions, purchase clusters and actual spending. Information for inclusion in the transaction behavior data source 210 can be obtained, for example, from payment card companies such as MasterCard, Visa, American Express, etc. (part of the payment card company network 150 in FIG. 1).

The transaction behavior information can contain, for example, billing activities attributable to the financial transaction processing entity (e.g., a payment card company) and purchasing and payment activities attributable to purchasers (e.g., payment card holders). Illustrative transaction behavior information can include, for example, financial (e.g., billing statements and payments), purchasing information, demographic (e.g., age and gender), geographic (e.g., zip code and state or country of residence), and the like.

In accordance with this disclosure, the transaction behavior information can contain predictive behavioral models generated by the payment card companies. The predictive behavioral models are generated based on information from the payment card companies. The selection of information for representation in the predictive behavioral models can be different in every instance. In one embodiment, all of the information can be used for selecting predictive behavioral models. In an alternative embodiment, only a portion of the information may be used. The generation and selection of predictive behavioral models can be based on specific criteria.

Predictive behavioral models are generated from the information obtained by the payment card company. The information is analyzed, extracted and correlated by, for example, a financial transaction processing company (e.g., a payment card company), and can include financial account information, performing statistical analysis on financial account information, finding correlations between account information and consumer behaviors, predicting future consumer behaviors based on account information, relating information on a financial account with other financial accounts, or any other method of review suitable for the particular application of the data, which will be apparent to persons having skill in the relevant art.

Activities and characteristics attributable to the payment card holders based on the one or more predictive behavioral models are identified. The payment card holders have a propensity to carry out certain activities and to exhibit certain characteristics based on the one or more predictive behavioral models. The activities and characteristics attributable to the payment card holders and based on the one or more predictive behavioral models are included in the transaction behavior data source.

Predictive behavioral models can be defined based on geographical or demographical information, such as age, gender, income, marital status, postal code, income, spending propensity, familial status, etc. In some embodiments, predictive behavioral models can be defined by a plurality of geographical and/or demographical categories.

Predictive behavioral models can also be based on behavioral variables. For example, the financial transaction processing entity database can store information relating to financial transactions. The information is used to determine an individual's likeliness to spend. An individual's likeliness to spend can be represented generally, or with respect to a particular industry (e.g., electronics), retailer (e.g., Macy's®), brand (e.g., Apple®), or any other criteria that can be suitable as will be apparent to persons having skill in the relevant art. An individual's behavior can also be based on additional factors, including but not limited to, time, location and season. For example, a predictive behavioral model can be based on consumers who are likely to spend on electronics during the holiday season, or on consumers whose primary expenses are in a suburb, but are likely to spend on restaurants located in a major city. The factors and behaviors identified can vary widely and can be based on the application of the information.

Behavioral variables can also be applied to generated predictive behavioral models based on the attributes of the entities. For example, a predictive behavioral model of specific geographical and demographical attributes (e.g., single males in a particular postal code between the ages of 26-30 with an income between $100,000 and $149,999) can be analyzed for spending behaviors. Results of the analysis can be assigned to the predictive behavioral models. For example, the above predictive behavioral model can be analyzed and reveal that the entities in the predictive behavioral model have a high spending propensity for electronics and can be less likely to spend money during the month of February.

In an embodiment, the information can be analyzed to determine behavioral information of the payment card holders. Also, information related to an intent of the payment card holders can be extracted from the behavioral information. The predictive behavioral models can be based upon the behavioral information of the payment card holders and the intent of the payment card holders. The predictive behavioral models can be capable of predicting behavior and intent in the payment card holders.

Predictive behavioral models can be developed, for example, to examine spend behaviors and create spend associations. A spend association can be a set of spend behaviors that predict another spend behavior. For example, people that tend to purchase jewelry display the following spend behaviors: spend at Macy's®, travel on cruise ships, go to the movie theaters once a month, and the like.

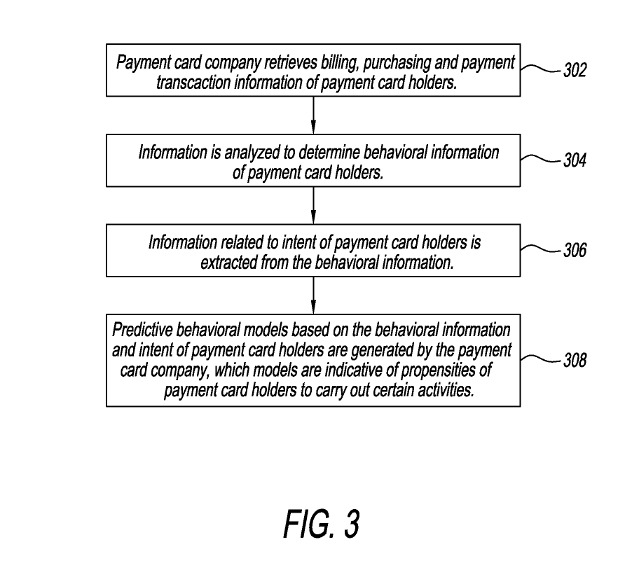

A method for generating one or more predictive behavioral models is an embodiment of this disclosure. Referring to FIG. 3, the method involves a payment card company retrieving, from one or more databases, information including activities and characteristics attributable to one or more payment card holders. The information 302 comprises payment card billing, purchasing and payment transactions, and optionally demographic and/or geographic information. The information is analyzed 304 to determine behavioral information of the one or more payment card holders. Information related to an intent 306 of the one or more payment card holders is extracted from the behavioral information. One or more predictive behavioral models are generated 308 based on the behavioral information and intent of the one or more payment card holders. The one or more payment card holders have a propensity to carry out certain activities based on the one or more predictive behavioral models.

In analyzing information to determine behavioral information, intent and other payment card member attributes are considered. Developing intent involves models that predict specific spend behavior in the future and desirable spend behaviors. Examples include as follows: likely to purchase at Macy's® in the next 2 weeks; likely to spend at least $100 in consumer electronics in the next 30 days; likely to purchase a car in the next 60 days; likely to be interested in golfing; likely to be up for a cell phone renewal in the next 60 days; likely to be a business traveler; and the like.

Predictive behavioral models can equate to purchase behaviors. There can be different degrees of predictive behavioral models with the ultimate behavior being a purchase. An example using Macy's® is as follows: an extreme behavior is a consumer purchasing something once a week at Macy's® and spending five times what the average customer spends; a medium behavior is a consumer purchasing something at Macy's® once a month and spending twice what the average customer spends; and a low behavior is a consumer purchasing something at Macy's® once a year and spending what the average customer spends.

There is the potential for numerous predictive behavioral models including, for example, industries (consumer electronics, QSR), categories (online spend, cross border), geography spend (spend in New York City, spend in London), geography residence (live in New York City, live in Seattle), day/time spend (weekday spend, lunch time spend), calendar spend (spend a lot around Christmas, spend a lot on flowers before Valentine's Day), top number of merchants, etc.

Other card holder attributes part of the information include, for example, geography (zip code, state or country), and demographics (age, gender, etc.).

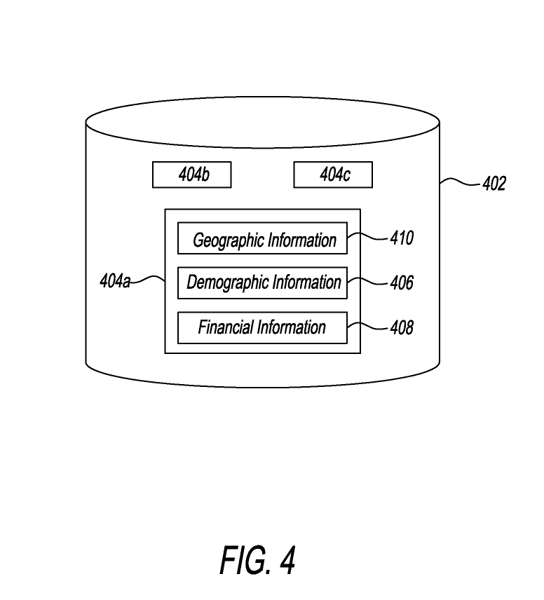

FIG. 4 illustrates an exemplary dataset 402 for the storing, reviewing, and/or analyzing of information used in generating predictive behavioral models. The dataset 402 can contain a plurality of entries (e.g., entries 404a, 404b, and 404c).

The demographic information 406 can include any demographic or other suitable information relevant to the particular application. For example, if a family restaurant is launching an advertising campaign and is requesting data of families with a spend propensity on restaurants, then the demographic information can include familial status, but not age. If a bar is launching an advertising campaign, then demographic information can include age, but not familial status. In some embodiments, the geographic information 410 can include geographic or other suitable information relevant to the particular application. Suitable types of information relevant for generating predictive behavioral models will be apparent to persons having skill in the relevant art. Likewise, the financial information 408 can include any financial information relevant to the particular application. For example, a dataset directed to advertisers in the food service industry can contain entries with financial information that includes a spend propensity for restaurants, but not a spend propensity for electronics.

The transaction behavior data source can include a wide variety of categories and attributes. In one embodiment, the transaction behavior data source can be based on spending propensity of spending index in a particular industry. Industries can include, as will be apparent to persons having skill in the relevant art, restaurants (e.g., fine dining, family restaurants, fast food), apparel (e.g., women's apparel, men's apparel, family apparel), entertainment (e.g., movies, professional sports, concerts, amusement parks), accommodations (e.g., luxury hotels, motels, casinos), retail (e.g., department stores, discount stores, hardware stores, sporting goods stores), automotive (e.g., new car sales, used car sales, automotive stores, repair shops), travel (e.g., domestic, international, cruises), and the like.

The transaction behavior data source can also include predictions of future behavior. For instance, a financial transaction processing company analyzes financial account information and behavioral information to predict future behavior of a payment card holder.

A financial transaction processing company (part of the payment card company network 150 in FIG. 1) can analyze the generated predictive behavioral models (e.g., by analyzing the stored data for each entity comprising the predictive behavioral model) for behavioral information (e.g., spend behaviors and propensities). In some embodiments, the behavioral information can be represented by a behavioral propensity score. Behavioral information can be assigned to each corresponding predictive behavioral model.

Predictive behavioral models or behavioral information can be updated or refreshed at a specified time (e.g., on a regular basis or upon request of a party). Updating predictive behavioral models can include updating the entities included in each predictive behavioral model with updated demographic data and/or updated financial data. Predictive behavioral models can also be updated by changing the attributes that define each predictive behavioral model, and generating a different set of behaviors. The process for updating behavioral information can depend on the circumstances regarding the need for the information itself.

Although the above relates primarily to financial data and spending behaviors, it will be apparent to persons having skill in the relevant art that the predictive behavioral models may be beneficial in a variety of other applications.

For instance, predictive behavioral models can have useful applications in measuring the effectiveness of advertising or other consumer campaigns. A party may desire to discover the effectiveness of a particular advertising campaign in reaching a specific set of consumers.

For example, a consumer electronics store wants to know the effectiveness of an advertising campaign initiated by the store and directed towards male consumers of a specific age and income group. The store provides the financial transaction processing company with the demographic (e.g., demographical and geographical) data corresponding to the market. The financial transaction processing company can identify predictive behavioral models with corresponding demographic data and summarize relevant spend behaviors for the identified predictive behavioral models. Summary of the relevant spend behaviors (e.g., showing an increase or decrease in spending at the consumer electronic store) for each predictive behavioral model (e.g., including the predictive behavioral models of ideal consumers) can be provided to the consumer electronics store.

Predictive behavioral model data can also be combined or matched with other sources of data. For example, other transaction processing agencies, advertising firms, advertising networks, publishers, and analogous groups can provide information on consumer groupings of their own. The financial transaction processing company can link or match the received consumer groupings, such as by matching groupings to generated predictive behavioral models based on geographical or demographical data.

Systems and methods disclosed herein can also have applications to the mobile communication device industry. For example, it is a common practice that mobile communication carriers provide mobile communication devices and services to consumers on a renewable contract for a specified time period (e.g., two years). The financial transaction processing company can analyze spending behaviors for financial accounts to generate a predictive behavioral model or individuals who may be nearing a renewal term on a contract with a mobile communication carrier (e.g., by identifying when a mobile communication device was purchased or two years of recurring payments to a mobile communication carrier). The individuals can be provided to a mobile carrier as an ideal consumer base representing consumers in a position to change mobile communication carriers or take advantage of new contract offers. As another example, business travelers can be identified as a result of spending behaviors (e.g., weekday spending, a plurality of hotel, restaurant, and airline transactions, etc.) for generation of corresponding behaviors. Other beneficial applications of the systems and methods disclosed herein will be apparent to persons having skill in the relevant art(s).

Methods for the creation of predictive behavioral models are also beneficial in the healthcare industry. For example, hospitals, pharmaceutical companies, and insurance companies are all highly regulated. The creation of predictive behavioral models and analysis of behavioral information can greatly benefit these entities. An insurance company can have a database of all of its customers, including demographic data and other health-related data. The insurance company can use a linking environment to combine the demographic and health data with relevant data provided by a hospital. Relevant data can include but is not limited to, prescription information, and illness information. The insurance company can combine the information and generate predictive behavioral models based on the demographic data health-related data, which can be analyzed to obtain potential health issues for entities in each predictive behavioral model or other useful information.

A pharmaceutical company can have demographical data on potential customer, and provide the geographical data to the insurance company. The insurance company can match each potential customer to a predictive behavioral model, and apply analyzed information, such as potential health issues for entities of that predictive behavioral model, to the potential customer.

Predictive behavioral models can also be useful in political campaign financing. Predictive behavioral models can also be beneficial in the profiling of potential consumers for the purposes of offering a payment card (e.g., a credit card). Predictive behavioral models can be used to identify consumer needs based on demographics and behavioral information in a much more efficient, more accurate fashion.

Referring to FIG. 2, the attitudinal data source 208 includes information related to payment card holder dynamics, satisfaction and concerns. Information for inclusion in the attitudinal data source 208 can be obtained, for example, from payment card companies such as MasterCard, Visa, American Express, etc. (part of the payment card company network 150 in FIG. 1).

The attitudinal information can contain, for example, information from surveys conducted by the financial transaction processing entity (e.g., a payment card company), spending behaviors, payment behaviors, growth opportunities, attitudes in the industry, supply and demand, product trends, and the like.

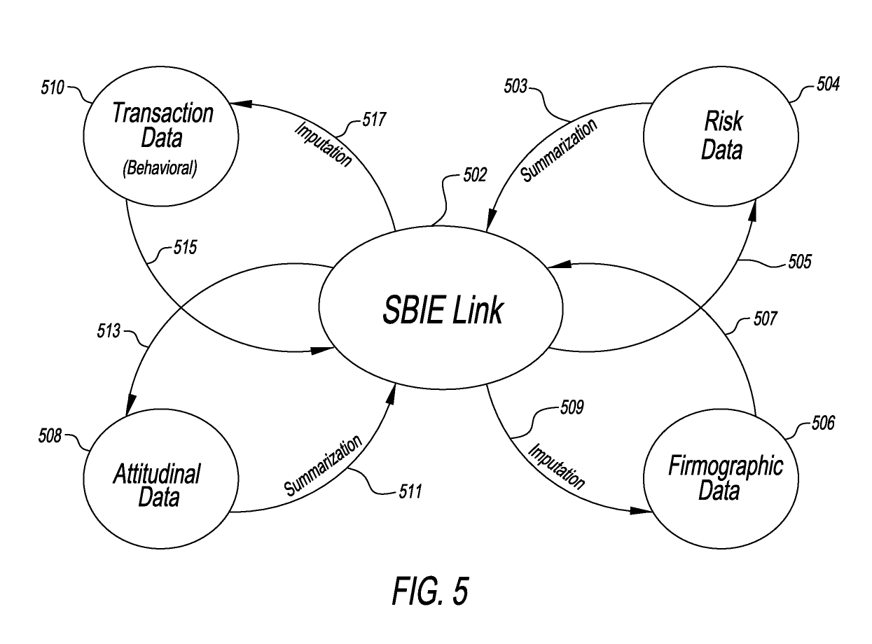

Referring to FIG. 5, to support analysis across the data sources, data is imputed into the four existing sources via the SBIE link. Data is summarized to the linkage level, and integrated summaries are imputed via the linkage.

In FIG. 5, risk data from risk data source 504 is summarized 503 to the SBIE link 502, and integrated summaries are imputed 505 to risk data source 504. Firmographic data from firmographic data source 506 is summarized 507 to the SBIE link 502, and integrated summaries are imputed 509 to firmographic data source 506. Attitudinal data from attitudinal data source 508 is summarized 511 to the SBIE link 502, and integrated summaries are imputed 513 to attitudinal data source 508. Transaction behavior data from transaction behavior data source 510 is summarized 515 to the SBIE link 502, and integrated summaries are imputed 517 to transaction behavior data source 510.

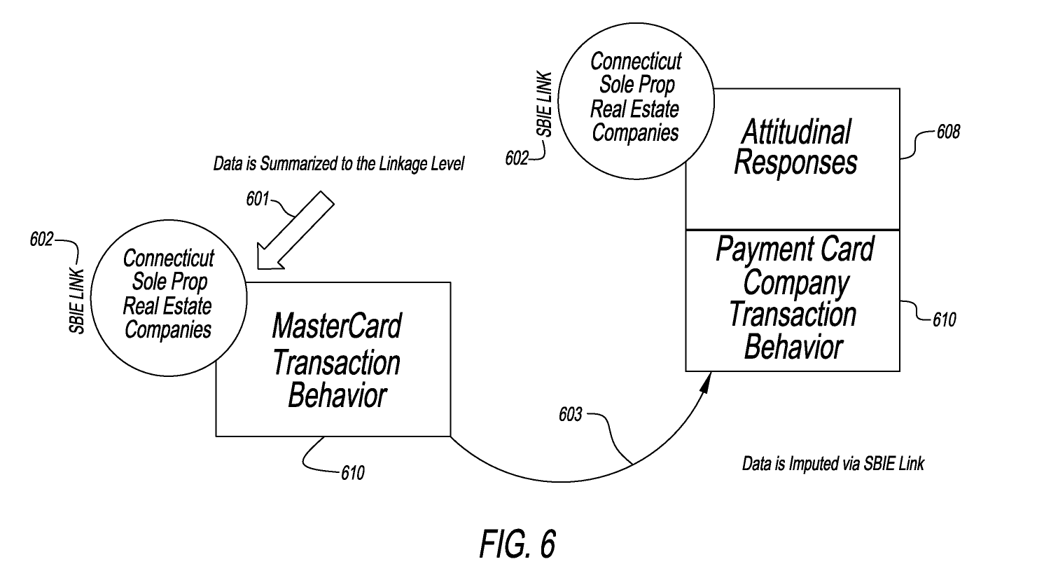

Referring to FIG. 6, the process shown in FIG. 5 by which data is summarized to the linkage level, and integrated summaries are imputed via the linkage can be demonstrated by using two data sources and an illustrative SBIE link. The example is directed to Connecticut sole proprietor real estate companies.

Transaction behavior data 610 from transaction behavior data source is summarized 601 to the SBIE link 602, and integrated summaries (i.e., transaction behavior data 610 and attitudinal data 608) are imputed 603 via the SBIE link 602. The integrated summaries include transaction behavior data and attitudinal data relating to Connecticut sole proprietor real estate companies.

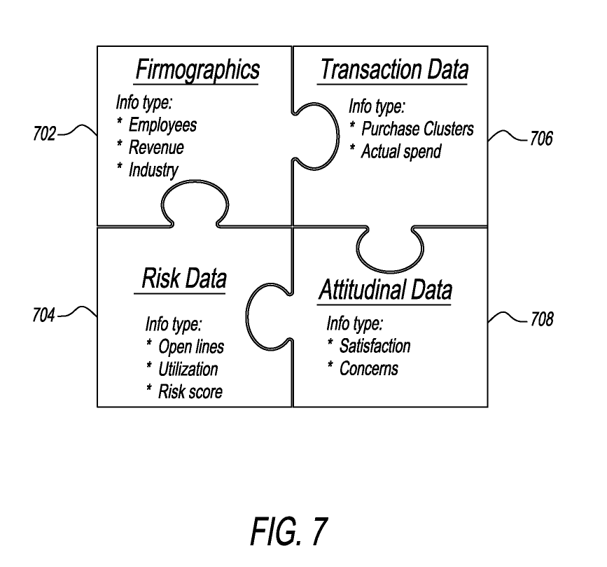

FIG. 7 shows illustrative information types included in each of the four linked data sources. Illustrative firmographic information types 702 include, for example, employees, revenue and industry. Illustrative risk data information types 704 include, for example, open lines, utilization and risk score. Illustrative transaction data information types 706 include, for example, purchase clusters and actual spend. Illustrative attitudinal data information types 708 include, for example, satisfaction and concerns.

In accordance with this disclosure, information from the one or more linked data sources is summarized to a link (i.e., SBIE). At the SBIE, at least some of the information is integrated by data fusion. The SBIE can also be referred to as a data fusion engine. At least some of the integrated information is imputed via the link to the business segment. This process is shown in more detail in FIGS. 5 and 6.

Data fusion algorithms can be employed to determine formulaic descriptions of the integration of the data source information including the firmographics data source, the risk data source, the transaction behavior data source, and the attitudinal data source, using any of a variety of known mathematical techniques. These formulas in turn can be used to derive or generate one or more models for each of the categories of business segments using any of a variety of available trend analysis algorithms.

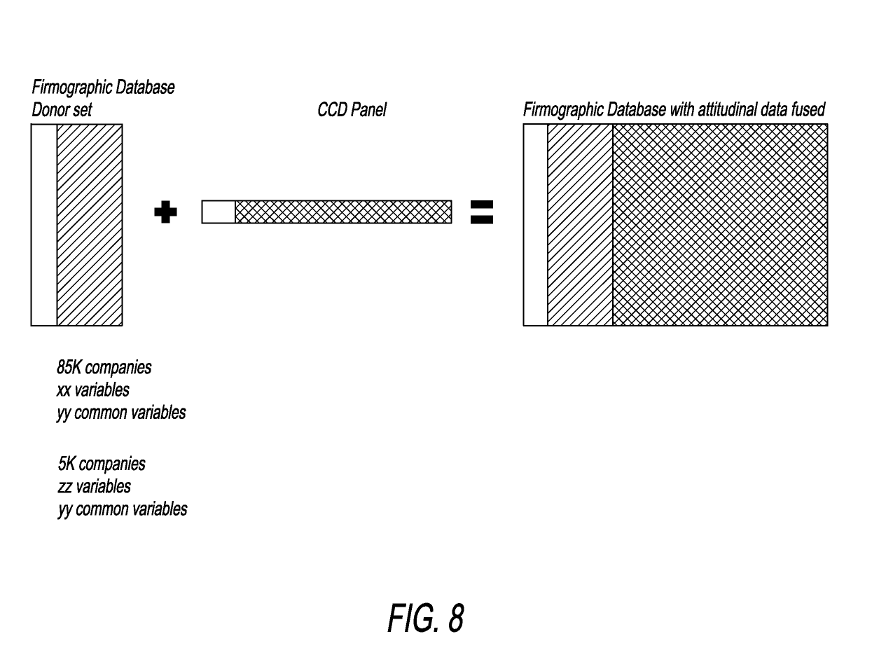

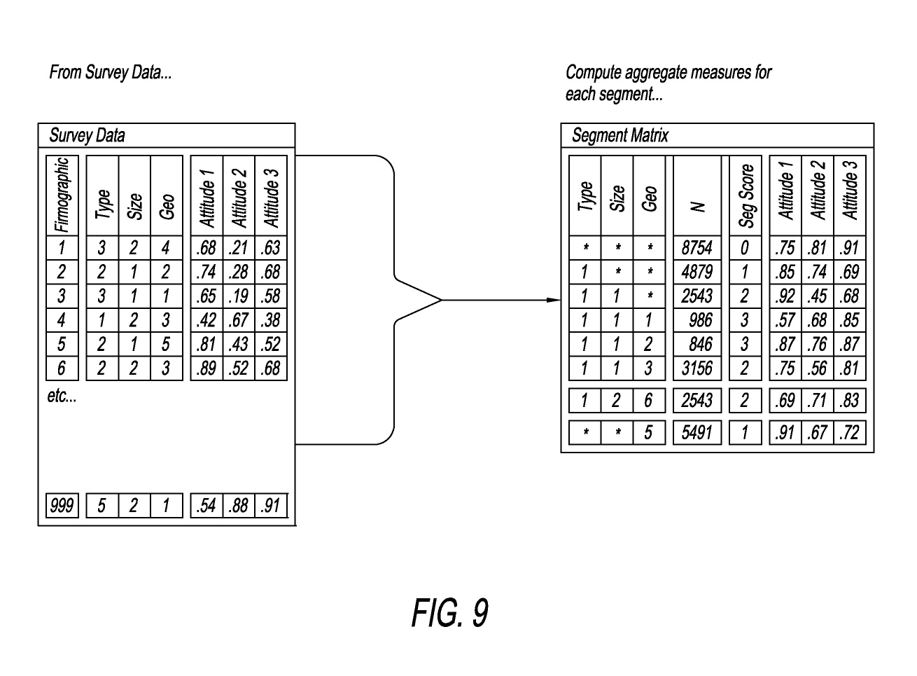

FIG. 8 gives an illustration of a data fusion algorithm used with an attitudinal data source and a firmographic data source. FIG. 9 shows illustrative data fusion algorithm computation of aggregate measures of segments from survey data.

The components of the data fusion engines, such as the data fusers, predictors, parameter modifiers, and converters, can represent functionality implemented in one or more of hardware, firmware, or software in combination with a processor unit to run the software. For example, data fusion engines useful herein can be a module or an application comprising instructions stored on hardware (distributed or not distributed), firmware, or any other computer-readable medium that, when executed by a processing unit, perform the functions of the data fusion engine. Examples of computer-readable media are described herein. Embodiments of systems and computer-readable media on which the data fusion engine may be implemented include processing units (microprocessors, multiprocessors, microcontrollers, computer processing units, and the like.).

It will be understood that the present disclosure may be embodied in a computer readable non-transitory storage medium storing instructions of a computer program which when executed by a computer system results in performance of steps of the method described herein. Such storage media may include any of those mentioned in the description above.

Where methods described above indicate certain events occurring in certain orders, the ordering of certain events may be modified. Moreover, while a process depicted as a flowchart, block diagram, etc. may describe the operations of the system in a sequential manner, it should be understood that many of the system's operations can occur concurrently or in a different order.

The terms “comprises” or “comprising” are to be interpreted as specifying the presence of the stated features, integers, steps or components, but not precluding the presence of one or more other features, integers, steps or components or groups thereof.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

The techniques described herein are exemplary, and should not be construed as implying any particular limitation on the present disclosure. It should be understood that various alternatives, combinations and modifications could be devised by those skilled in the art from the present disclosure. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A system for acquiring an understanding of a business segment, said system comprising:
an electronic storage device having a database of information stored therein, said information generated from at least four linked data sources including a firmographics data source, a risk data source, a transaction behavior data source, and an attitudinal data source;
an access path for allowing access to said information concerning the business segment; and
a processor for assembling said information concerning the business segment, wherein the assembling includes information from one or more of the linked data sources being summarized to a link, at least some of the information is integrated by data fusion, and at least some of the integrated information is imputed via the link to the business segment, wherein the processor provides the assembled information to a user that has been granted access to the database.

2. The system of claim 1, wherein the business segment is a small business segment.

3. The system of claim 1, further comprising additional linked data sources.

4. The system of claim 1, wherein the firmographics data source includes information related to employees, revenues and industries.

5. The system of claim 1, wherein the risk data source includes information related to open lines of credit, utilization and risk score.

6. The system of claim 1, wherein the transaction behavior data source includes information related to payment card transactions, purchase clusters and actual spending.

7. The system of claim 1, wherein the attitudinal data source includes information related to payment card holder dynamics, satisfaction and concerns.

8. The system of claim 1, wherein the link comprises a data fusion engine.

9. The system of claim 1, wherein the access path comprises a web site for making the data in said database available to users of the web site.

10. The system of claim 9, wherein the access path includes an Internet connected device for connecting to the web site.

11. The system of claim 10, wherein the Internet connected device is one selected from the group consisting of a mobile telephone, a computer, a tablet, and a personal digital assistant.

12. A method for acquiring an understanding a business segment, said method comprising:
storing, in an electronic storage device, a database of information, said information generated from at least four linked data sources including a firmographics data source, a risk data source, a transaction behavior data source, and an attitudinal data source;
accessing, in the database, information concerning the business segment;
assembling the information concerning the business segment, wherein the assembling includes information from one or more of the linked data sources being summarized to a link, at least some of the information is integrated by data fusion, and at least some of the integrated information is imputed via the link to the business segment; and
providing the assembled information to a user that has been granted access to the database.

13. The method of claim 12, wherein the business segment is a small business segment.

14. The method of claim 12, further comprising additional linked data sources.

15. The method of claim 12, wherein the firmographics data source includes information related to employees, revenues and industries.

16. The method of claim 12, wherein the risk data source includes information related to open lines of credit, utilization and risk score.

17. The method of claim 12, wherein the transaction behavior data source includes information related to payment card transactions, purchase clusters and actual spending.

18. The method of claim 12, wherein the attitudinal data source includes information related to payment card holder dynamics, satisfaction and concerns.

19. The method of claim 12, wherein the access path comprises a web site for making the data in the database available to users of the web site.

20. The method of claim 19, wherein the access path includes an Internet connected device for connecting to the web site.

21. The method of claim 20, wherein the Internet connected device is one selected from the group consisting of a mobile telephone, a computer, a tablet, and a personal digital assistant.

22. A computer readable non-transitory storage medium storing instructions of a computer program which when executed by a computer system results in performance of steps of:
storing, in an electronic storage device, a database of information, said information generated from at least four linked data sources including a firmographics data source, a risk data source, a transaction behavior data source, and an attitudinal data source;
accessing, in the database, information concerning a business segment;
assembling the information concerning the business segment, wherein the assembling includes information from one or more of the linked data sources being summarized to a link, at least some of the information is integrated by data fusion, and at least some of the integrated information is imputed via the link to a business segment; and
providing the assembled information to a user that has been granted access to the database.
